(19) United States
(12) Patent Application Publication
(10) Pub. No.: US 2024/0057225 A1
(43) Pub. Date: Feb. 15, 2024

(54) Electrical Heating Device

(71) Applicant: Eberspächer catem GmbH & Co. KG, Herxheim (DE)

(72) Inventors: Ahmad Asafi, Karlsruhe (DE); Adriana Münich, Ludwigshafen am Rhein (DE)

(21) Appl. No.: 18/232,657

(22) Filed: Aug. 10, 2023

(30) Foreign Application Priority Data
Aug. 12, 2022 (DE) 10 2022 120 417.0

(51) Int. Cl. H05B 3/60; H05B 3/03; H05B 1/02

(52) U.S. Cl. CPC H05B 3/60; H05B 3/03; H05B 1/0297; H05B 2203/02; H05B 2203/021; H05B 2203/022

(57) ABSTRACT

An electrical heating device has several cartridges disposed one above the other, each of which has two openings disposed on opposite face side surfaces. One of the openings forms an inlet, and another of the openings forms an outlet. Deflection devices deflect flow within the cartridges from a first cartridge to a second cartridge that is adjacent to the first cartridge. A PTC heating device is provided between two adjacent cartridges and is coupled in a thermally conductive manner to flow channels provided in the adjacent cartridges.

### BACKGROUND OF THE INVENTION

### 1. Field of the Invention

The present invention relates to an electrical heating device. The present invention intends to specify in particular an electrical heating device that is scalable and can accordingly be easily adapted to different performance requirements. The electrical heating device should be able to be produced inexpensively and enable a simple structure.

### SUMMARY

In this regard, the present invention proposes an electrical heating device having several cartridges disposed one above the other, each of which has at least two openings on oppositely disposed face side surfaces thereof. One of the openings forms an inlet, and another of the openings forms an outlet. A flow channel extends between the inlet and the outlet of each cartridge. Deflection devices are provided, each of which is configured to deflect flow from a first cartridge to a second cartridge that is adjacent to the first cartridge. A PTC heating device is provided between two adjacent cartridges and is coupled in a thermally conductively manner to the flow channels in the two adjacent cartridges.

Several cartridges may be disposed one above the other so as to enclose a PTC heating device between them. In one embodiment, at least two of the flow channels in each cartridge provide fluid flow in opposite directions. This results in heat transfer based on the counter flow principle. A partition wall, which is typically formed by the cartridge itself and which typically extends up to the openings on both face side surfaces, may be provided between the two flow channels.

The deflection device is typically provided on the oppositely disposed face side surface of the cartridges. The cartridges may be provided one above the other to form a stack. Two superimposed cartridges may form the smallest unit for realizing the electrical heating device according to the invention. The deflection device fluidically connecting the two adjacent cartridges to one another is also referred to hereafter as a “stack deflection device.” The stack deflection device connects at least two openings of two different cartridges that are provided on the same face side surface. In the case of an electrical heating device with only two cartridges, the inlet opening as well as the outlet opening of the electrical heating device are located on this face side surface.

A deflection device deflecting flow within a cartridge is referred to hereafter as “a cartridge deflection device.”

It goes without saying that a plurality of cartridges can be stacked one above the other with a PTC heating device provided between the respective cartridges. A PTC heating device comprises at least one PTC element. This is a ceramic semiconductor component which is also typically contacted on opposite sides to conductor tracks that are assigned different polarities. The conductor tracks can be formed by oppositely disposed surfaces of the cartridges. However, the conductor tracks are typically formed by separate conduction elements, in particular contact plates, which abut against the surfaces of the cartridges in a thermally conductive manner and enclose between them the at least one PTC element. In the case of a potential-free arrangement, the conductor tracks and the PTC elements are typically disposed between two insulating layers abutting against the conductor tracks on the outside. The individual cartridges can then be formed from a metal having good thermal conductivity.

The relatively simple geometry of the cartridges also makes it possible to produce them from ceramic material, for example, by the extrusion of a green body and subsequent sintering. On the respective face side surfaces, such a semi-finished product substantially forming the cartridge can be provided with deflection devices, which can be produced inexpensively in the final contour, and be connected thereto in a sealing manner. These deflection devices can be made of, for example, plastic material, which is desirable with regard to good insulation in the region of the deflection. The cartridges themselves should have good thermally conductive properties at least where the PTC heating device is arranged between the cartridges. The surfaces provided there are also referred to hereafter as lid elements. The lid elements can be made of a different material than the remainder of the cartridge, which is formed to be substantially frame-shaped.

Several PTC elements, which are associated with different heating circuits, can be provided between adjacent cartridges. For this purpose, several conductor tracks are provided at least on one side of the PTC elements and can be arranged electrically separated from one another and be controlled separately. Each individual heating circuit formed in this manner has a connection lug for the electrical connection of the respective heating circuit.

The heating circuit or circuits are electrically connected by way of these connection lugs.

According to a preferred development of the present invention, these connection lugs are disposed on a single side surface between the cartridges and there protrude from the cartridges. Accordingly, all the connection lugs of the PTC heating device provided between the two cartridges are exposed on a side surface between the cartridges. A contacting device, via which all the connection lugs are contacted to a control device, is disposed on this side surface. The control device is provided on an edge cartridge of the stack. The control device is typically in direct contact with a lid element of this cartridge at the edge. It goes without saying that the control device may be provided in a separate housing and is protected from environmental influences.

The contacting device can be formed to be a conductor track, as is described in EP 2 505 931 A1 and its U.S. counterpart U.S. Pat. No. 9,273,882, the subject matter of each of which hereby is incorporated by reference in its entirety. Such a contacting device is typically plugged into a printed circuit board of the control device. The printed circuit board of the contacting device typically extends at a right angle to the printed circuit board of the control device.

The control device typically has a power transistor that generates thermal dissipation loss. It is coupled in a thermally conductively manner to at least one flow channel of the associated cartridge so that the thermal dissipation loss generated can also be used to heat the fluid to be heated.

The electrical heating device according to the invention is particularly suitable for heating in mobile vehicles on water, on land, or in the air. The electrical heating device is suitable for heating gaseous as well as for heating fluid media. It goes without saying that the power transistor generating the thermal dissipation loss should be associated with the flow channel on the inlet side in which the fluid has a lower temperature than in the flow channel on the outlet side and therefore has better heat absorption capacity. For corresponding considerations, the power transistor should be arranged as close as possible to the inlet opening of the corresponding flow channel.

According to a preferred development of the present invention, the cartridges each have lid elements on oppositely disposed sides. They cover a frame of the cartridge forming the openings. The lid elements can be made of a material having good thermal conductivity, whereas the frame can be made of a different material, for example, plastic material, which exhibits poorer thermal conductivity than metal. The insulation in the circumferential direction through the frame is indeed desirable in order to avoid heat losses. The PTC heating device is provided between the lid elements of adjacent cartridges.

The lid elements themselves can form the conductor tracks. A lid element can form several electrically separate conductor tracks which are electrically insulated from one another and can be electrically insulated from the fluid. The lid elements receiving between them the PTC heating device have a surface design, typically on the inner surface disposed opposite the PTC heating device which disturbs the formation of a laminar flow within the flow channel(s). Such a surface design can have projections or waves or edges, respectively, extending transverse to the main direction of flow, respectively. The respective design can be formed by roughening the inner surface of the lid element. It goes without saying that such a design is dispensed with where the partition wall is abutted against the inner surface of the lid element, typically in a sealing manner. The surface design can also be formed, for example, by embossing a lid element formed from sheet metal. Shot blasting or sand blasting the lid element is also conceivable for the modification of the surface with regard to the best possible disruption of a laminar surface.

Improved heat transfer at a slightly increased pressure drop of the medium flowing through the electrical heating device is achieved in that the cartridges each form a widened flow inlet section and a widened flow outlet section and that a heat transfer section that is more tapered in the flow cross section than compared to the flow inlet and the flow outlet section is provided between these two inlet and outlet sections. The widening may be provided in the height direction of the stack. It goes without saying that such a structure is particularly well-suited for implementation in a stack with only two cartridges. In the tapered heat transfer section, there is a relatively small gap for the passage of the fluid to be heated through the electrical heating device. In this way, the flow is always guided relatively close to an inner surface that is directly connected in a thermally conductive manner to the PTC heating device. The increased flow rate in the tapered heat transfer section typically results in a turbulent flow which further improves the heat transfer at the inner surface.

In terms of further scaling, to provide two identical cartridge modules may be joined together, each forming one of the cartridges.

The lid element mentioned above can cover the cartridge as well as the cartridge deflection device which in the plane of the cartridge covers the latter on the one face side surface and extends it on the outer circumference and has a semicircular arc that connects the one flow channel to the other flow channel such that the flow between the two channels suffers only a small pressure loss.

### BRIEF DESCRIPTION OF THE DRAWINGS

Further details and advantages of the present invention shall arise from the following description of embodiments in conjunction with the drawing, where:

FIG. 1 shows a perspective side view of a first embodiment;

FIG. 2 shows a perspective top view of a cartridge of a second embodiment;

FIG. 3 shows a perspective top view onto a stack using the cartridge according to FIG. 2;

FIG. 4 shows a perspective side view of a variant of the embodiment of an electrical heating device shown in FIG. 1;

FIG. 5 shows a perspective exploded view of the embodiment substantially according to FIG. 2 with two lid elements raised therefrom;

FIG. 6 shows a perspective top view onto a variant of a lid element according to FIG. 4 and

FIG. 7 shows a perspective side view of a further embodiment of the present invention.

### DETAILED DESCRIPTION

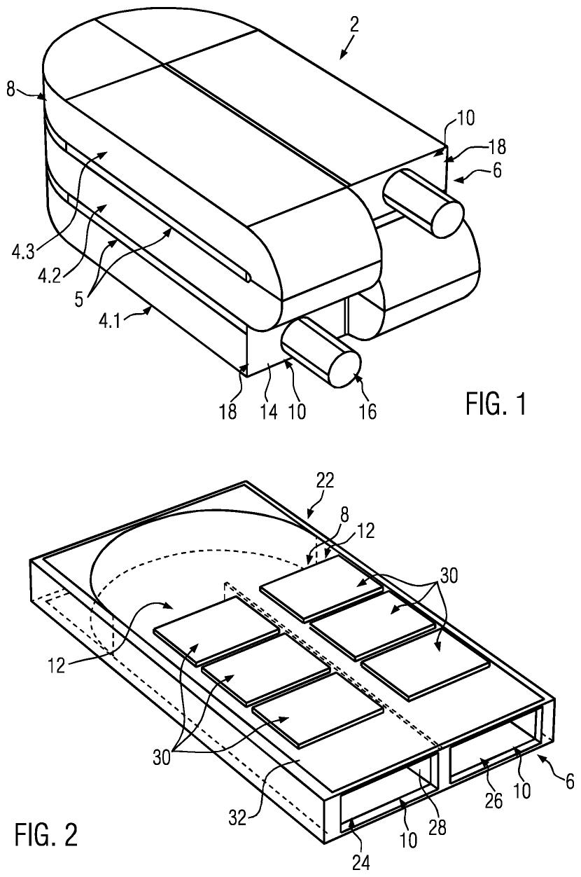

FIG. 1 shows an electrical heating device 2 with several cartridges 4. In the present case, three cartridges 4 are stacked one above the other. The PTC heating devices 5 are provided between the cartridges 4 and shall be explained in more detail below.

The cartridges 4 on one of their respective face side surfaces 6 and 8 each form two openings which are identified in FIG. 2 by reference character 10 for the first face side surface 6 and reference character 12 for the second face side surface 8. In the embodiment according to FIG. 1, the left-hand opening 10 of the lower cartridge 4.1 is closed with a cover cap 14 from which a connection port 16 protrudes. A connection element is formed by the cover cap 14 with the connection port 16. The connection element is identified by reference character 18 and is formed integrally, for example, from plastic material. A correspondingly formed connection element 18 closes the opening 10 of the upper cartridge 4.3 shown in FIG. 1 at the top right hand side.

Further openings 10 on said face side surface 6 are connected by the stack deflection devices 20. These stack deflection devices 20 connect the superimposed cartridges 4 to one another in a fluidic manner. The stack deflection devices 20 can be formed by two 90° angle elements deflecting the flow that are made of plastic material and joined together.

On the oppositely disposed face side surface 8, the flow is deflected by the cartridge deflection devices 22 which are in communication with the respective openings 12 and connected thereto. The cartridge deflection devices are likewise made of plastic material. They can also have two 90° elbow sections which each form the cartridge deflection devices. The cartridge deflections devices deflect the flow from one flow channel into another flow channel formed within the cartridge 4. The respective flow channels are identified by reference characters 24 and 26 in FIG. 2. The two flow channels 24, 26 are separated by a partition wall which is provided within the cartridge 4 and identified by reference character 28 in FIG. 2.

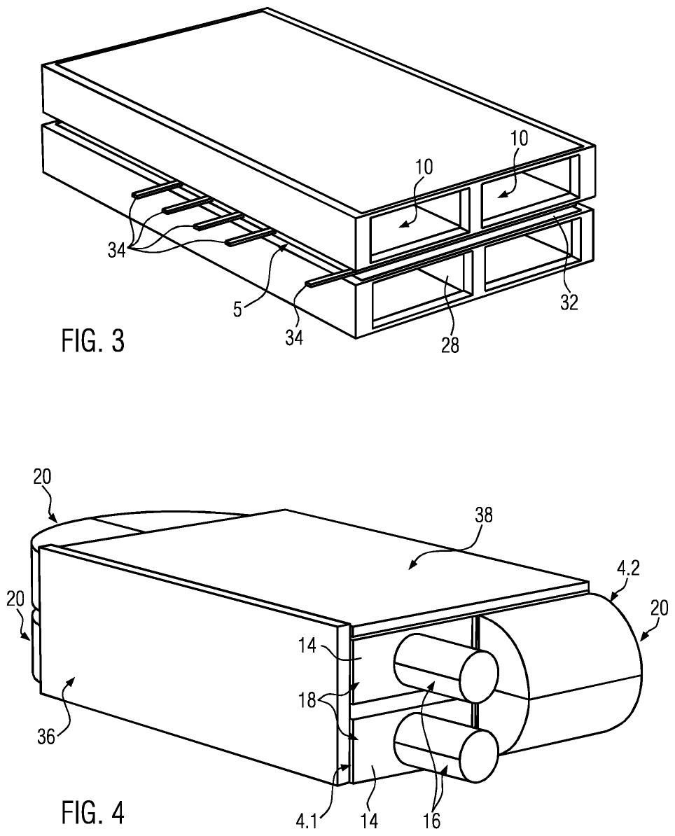

FIG. 2 shows that the cartridge 4 is made of a respective frame-shaped element which in the embodiment according to FIGS. 2 and 3 continues over the cartridge deflection device 22. In the embodiment shown, six PTC elements 30 are provided at the height of the flow channels 24, 26 and are associated with a conductor track identified by reference character 32. The conductor track 32 is presently made of a metal strip on which connection lugs identified by reference character 34 in FIG. 3 are formed integrally by punching and bending. The respective connection lugs 34 protrude from a single side surface of the cartridges 4. FIG. 4 schematically illustrates a wiring circuit board 36 which electrically receives the corresponding connection lugs 34 and groups them to form heating circuits. The wiring circuit board 36 is electrically connected to a populated circuit board 38 which is provided in a control housing indicated schematically in FIG. 4 and represents an embodiment of a control device.

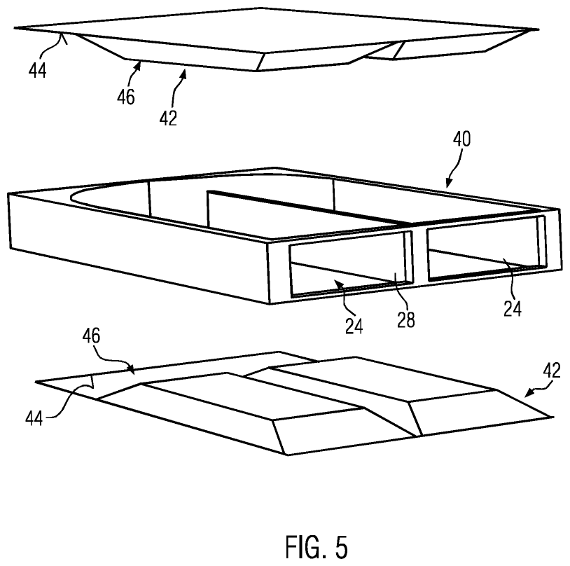

FIG. 5 shows the three components of the cartridge 4 in a perspective view. The cartridge 4 has a frame element that is made, for example, of plastic material and is identified by reference character 40. The frame element 40 integrally forms a frame that defines the flow channels 24, 26 and the partition wall 28. The boundary surfaces on the face side with the openings 10 or openings 12, respectively, are likewise formed by the frame element 40.

The cartridge deflection device 22 is also arranged in the plane of the frame element 40. This cartridge deflection device 22 and the cartridge 4 are connected to one another by two lid elements 42 which can be made or formed from, for example, a metal, in particular a metal sheet. The corresponding lid elements 42 are connected, for example, adhesively bonded or welded or soldered, respectively, to the frame element 40 and the cartridge deflection device 22.

FIG. 5 shows that the lid elements 42 form a surface design that disrupts a laminar flow, in the present case in the form of the ramps 46. As can be seen, the outer surface disposed opposite to the inner surface 44 is flat for the planar and thermally conductive abutment of the PTC heating device 5. FIG. 5 also shows that the lid element 42 covers the cartridge deflection device 22.

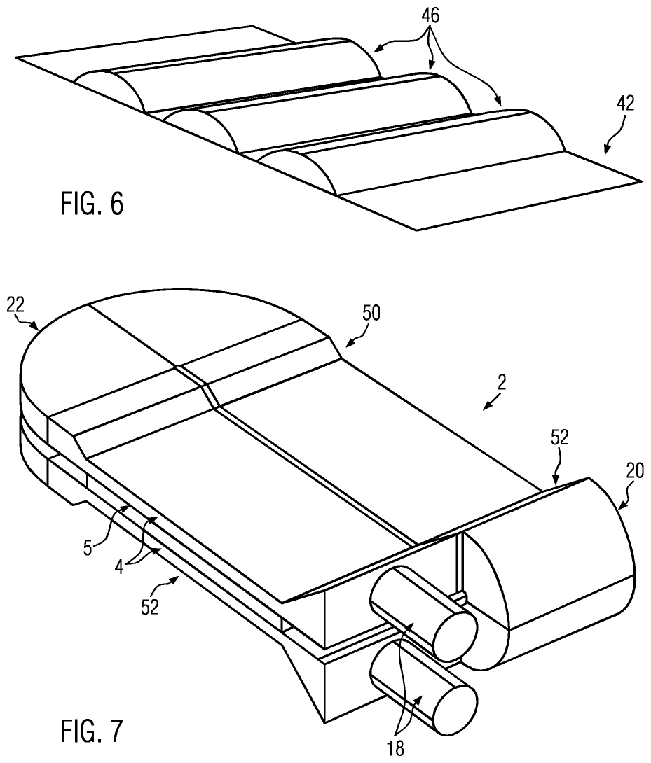

FIG. 6 shows a variant of a lid element 42 with a wave-shaped surface design 46 for the disruption of a laminar flow on the inner surface 44.

FIG. 7 shows a variant with improved heat transfer, but with a slightly increased loss of flow of the medium flowing through the electrical heating device 2.

The embodiment according to FIG. 7 has a widened flow inlet section 48 and a widened flow outlet section 50. The widened sections 48, 50 each have the aforementioned openings 10, 12 and are provided with the connection elements 18 and the deflection devices 20 and 22, respectively. Provided between the respective sections 48, 50, which each have a widened flow cross section on the face side surfaces 8, is a heat transfer section 52 which is slot-shaped in cross section and therefore has a smaller flow cross section than the inlet and outlet sections 48, 50. The transfer of the heat generated by the PTC heating device 5 takes place there.

1. An electrical heating device comprising:
several cartridges disposed one above the other, each of which has at least two openings on oppositely disposed face side surfaces thereof, wherein one of the openings forms an inlet and another of the openings forms an outlet, and wherein a flow channel extends between the inlet and the outlet of each cartridge;
deflection devices, each of which is configured to deflect flow from a first cartridge to a second cartridge that is adjacent to the first cartridge; and
a PTC heating device that is provided between two adjacent cartridges and that is coupled in a thermally conductively manner to the flow channels in said two adjacent cartridges.

2. The electrical heating device according to claim 1, wherein, wherein the cartridges are arranged in a stack having an edge, wherein said PTC heating device is provided with electrical connection lugs which protrude on a side surface of the electrical heating device between said two adjacent cartridges, and wherein all connection lugs exposed on said side surface are contacted by way a common contacting device to a control device which is associated with a cartridge at the edge of the stack.

3. The electrical heating device according to claim 2, wherein a wiring circuit board on said side surface is in a plugged connection to said connection lugs and is in a plugged connection to a circuit board of said control device.

4. The electrical heating device according to claim 2, wherein at least one power transistor of said control device, generating thermal dissipation loss, is coupled in a thermally conductive manner to at least one flow channel of an associated cartridge.

5. The electrical heating device according to claim 1, wherein said cartridges each have lid elements on oppositely disposed sides thereof, wherein the lid elements cover a frame element forming said openings, and wherein the lid elements of adjacent cartridges receive said PTC heating device between them.

6. The electrical heating device according to claim 5, wherein at least one of the lid elements is disposed opposite to the PTC heating device and has an inner surface that has a surface design which disrupts formation of a laminar flow.

7. The electrical heating device according to claim 6, wherein said surface design is formed by embossing a metal sheet forming the at least one lid element.

8. The electrical heating device according to claim 1, wherein said cartridges each form a widened flow inlet section and a widened flow outlet section, wherein said flow inlet section and said flow outlet section each form said openings, and wherein said PTC heating device is associated with a heat transfer section that is more tapered in flow cross section when compared to said flow inlet section and said flow outlet section.

9. The electrical heating device according to claim 1, wherein each cartridge is formed by two identical cartridge modules joined together.
